(19) United States
(12) Patent Application Publication
(10) Pub. No.: US 2005/0196497 A1
(43) Pub. Date: Sep. 8, 2005

(54) Antimicrobial effect of chitosan in beverages

(75) Inventors: Helena Setyarini Soedjak, Spring Lake, MI (US); Gregory Aaron Wiseman, New York, NY (US)

Correspondence Address: KRAFT / FETF, 120 S. LASALLE STREET, SUITE 1600, CHICAGO, IL, 60603-3406, US

(73) Assignee: Kraft Foods Holdings, Inc.

(21) Appl. No.: 10/792,502

(22) Filed: Mar. 3, 2004

(51) Int. Cl. A23C 3/00

(52) U.S. Cl. 426/324

(57) ABSTRACT

The present invention is directed to compositions and methods which utilize a first antimicrobial compound (i.e., chitosan, tannic acid, or mixtures thereof) in combination with a second antimicrobial compound (preferably benzoate, sorbate, EDTA, or mixtures thereof) to inhibit the growth of microorganisms in food products and especially in beverages. The present invention is also directed to cold fill compositions and cold fill methods using chitosan alone or in combination with the second antimicrobial compound (preferably benzoate, sorbate, EDTA, or mixtures thereof), to kill microorganisms and/or inhibit the growth of microorganisms in beverages.

### FIELD OF THE INVENTION

The present invention is directed to methods of killing microorganisms and/or inhibiting their growth in beverages, particularly beverages containing fruit juice, by adding a first antimicrobial compound (i.e., chitosan, tannic acid, or mixtures thereof) and a second antimicrobial compound (especially benzoate, sorbate, EDTA, and mixtures thereof). In addition, the invention is directed to beverages that contain chitosan alone or in combination with second antimicrobial compound.

### BACKGROUND OF THE INVENTION

A major concern in the making of beverages for human consumption is the growth of microorganisms. Fruit juice-containing drinks provide a particularly good environment for the growth of bacteria, mold, and yeast. Unless measures are taken to control such growth, these products rapidly deteriorate. Methods of inhibiting microbial growth include heat pasteurization during packaging (hot packing), and the use of aseptic packing conditions. Although these methods are highly effective in eliminating microorganisms responsible for spoilage, they are expensive, unsuitable for certain beverages, and incompatible with some types of containers.

Preservatives such as sorbates and benzoates may also be included in beverages to reduce microbial growth and are typically present when cold fill packing methods are used. However, a balance must be struck between an effective concentration of preservative and a tendency to adversely affect flavor as concentration increases. As a result, better preservative compositions are constantly being sought.

Attempts to develop more effective preservatives have included: the use of salts of polyphosphates to enhance the potency of sorbate preservatives (U.S. Pat. No. 5,431,940; see also U.S. Pat. Nos. 6,294,214 and 6,440,482); the use of dialkyl dicarbonates (U.S. Pat. No. 3,979,524); combining a sorbate preservative with natamycin and a dialkyl dicarbonate (U.S. Pat. No. 6,376,005); and combining sorbate or benzoate salts with ascorbic acid and with dimethyl dicarbonate (U.S. Pat. No. 5,866,182). Ideally, a preservative composition should have a wide spectrum of activity (i.e., killing and/or inhibiting the growth of bacteria, mold, and yeast), be safe for human consumption, be effective at low concentration, be inexpensive, and not adversely effect the flavor of the beverage to which it is added.

### SUMMARY OF THE INVENTION

The present invention is based upon the discovery that chitosan works synergistically with other preservatives (particularly benzoate, sorbate, EDTA, and mixtures thereof) to kill and/or prevent the growth of bacteria, yeast, and mold in ready-to-drink beverages, including juice-containing ready-to-drink beverages. This has at least two important consequences. First, a combination of chitosan with benzoate, sorbate, EDTA, or mixtures thereof is more effective than when these agents are used alone. Second, when used in combination, these antimicrobials are effective at lower concentrations. Another agent that is believed to produce similar results to chitosan is tannic acid.

Generally, the invention is directed to a method of killing and/or inhibiting the growth of microorganisms in a beverage by adding a first antimicrobial compound (chitosan, tannic acid, or mixtures thereof) together with second antimicrobial compound (e.g., benzoate, sorbate, EDTA, or mixtures thereof). The first antimicrobial compound and second antimicrobial compound are added to a concentration sufficient, in their combined action, to reduce and maintain microorganism levels to less than about 1 cfu/ml for at least about 8 weeks at room temperature. Using the present invention, it is not necessary to use heat treatments to inactivate food spoilage microorganism, including yeasts and mold. Thus, cold packing methods can be used. Of course, such heat treatments could be used if desired.

In another embodiment, the invention is directed to a method of killing and/or inhibiting the growth of microorganisms in a beverage by adding a first antimicrobial compound (i.e., chitosan, tannic acid, or mixtures thereof) together with a second antimicrobial compound. The first and second antimicrobial compounds are added to a concentration sufficient, in their combined action, to reduce and maintain microorganism levels to less than about 1 cfu/ml for at least about 8 weeks at room temperature.

Preferably the second antimicrobial compound used in the methods described above is benzoate, sorbate, EDTA (ethylenediamine tetraacetic acid), or mixtures thereof. These may be added in any form compatible for use in a food product (e.g., as sodium or potassium salts).

In one embodiment, this invention provides a method of killing and/or inhibiting the growth of microorganisms in a packaged food product, comprising adding a first antimicrobial compound selected from the group consisting of chitosan, tannic acid, or mixtures thereof and a second antimicrobial compound, wherein the first antimicrobial compound and second antimicrobial compound are added to a concentration sufficient, in their combined action, to reduce and maintain microorganism levels in the packaged food product to less than about 1 cfu/ml for at least about 8 weeks at room temperature.

In another embodiment, the present invention provides a packaged beverage comprising a first antimicrobial compound selected from the group consisting of chitosan, tannic acid, or mixture thereof and a second antimicrobial compound, wherein the first antimicrobial compound and second antimicrobial compound are added at a concentration sufficient, in their combined action, to reduce and maintain microorganism levels in the packaged beverage to less than about 1 cfu/ml for at least about 8 weeks at room temperature.

In another embodiment, the present invention provides a process for providing a cold fill packaged beverage, the process comprising:
(1) preparing a beverage, wherein the prepared beverage comprises a first antimicrobial compound selected from the group consisting of chitosan, tannic acid, or mixture thereof and a second antimicrobial compound selected from the group consisting of benzoate, sorbate, EDTA, and mixtures thereof;
(2) placing the prepared beverage in an container;
(3) sealing the container to provide the cold fill packaged beverage,
wherein steps (2) and (3) are carried out at a temperature of 0 to about 80° C.; and wherein the first antimicrobial compound and second antimicrobial compound are added to the beverage at a concentration sufficient, in their combined action, to reduce and maintain microorganism levels in the cold fill packaged beverage to less than about 1 cfu/ml for at least about 8 weeks at room temperature.

In still another embodiment, the present invention provides a process for providing a cold fill packaged beverage, the process comprising:
(1) preparing a beverage, wherein the prepared beverage comprises a chitosan;
(2) placing the prepared beverage in an container;
(3) sealing the container to provide the cold fill packaged beverage,
wherein steps (2) and (3) are carried out at a temperature of 0 to about 80° C.; and wherein the chitosan is added to the beverage at a concentration sufficient, to reduce and maintain microorganism levels in the cold fill packaged beverage to less than about 1 cfu/ml for at least about 8 weeks at room temperature.

### DETAILED DESCRIPTION OF THE INVENTION

Chitosan is a polysaccharide typically produced by the deacetylation of chitin in base at high temperature. Although chitin is insoluble in most solvents, chitosan dissolves in dilute solutions of organic acids, including citric acid. Methods for solubilizing chitosan in a variety of liquids are well known in the art (see, e.g., U.S. Pat. No. 5,453,282; U.S. Pat. No. 5,654,001; and U.S. Pat. No. 6,323,189). It has been used in a number of biomedical applications and has, in recent years, become a popular dietary supplement.

Tannic acid and chitosan have been experimentally tested and have been found to work synergistically with sorbate/benzoate or sorbate/benzoate/EDTA in ready-to-drink beverages and especially in juice-containing ready-to-drink beverages. Sorbate is a commonly used preservative and has been found to be effective against mold, yeast, and certain types of bacteria. Benzoate has a similar range of activity, although it is generally somewhat less potent than sorbate, and operates best in an acidic environment. EDTA is a common chelating agent that traps metal impurities in foods that would otherwise promote microbial growth and rancidity. All of these agents are available commercially from a variety of sources.

The present methods and compositions are most useful in fruit juice-containing beverages which may be either carbonated or non-carbonated. The juices preferably include citric acid-containing juices such as orange juice, lemon juice, lime juice, grapefruit juice, tangerine juice, and mixtures thereof. Other fruit juices that may be used include apple juice, grape juice, pear juice, nectarine juice, currant juice, raspberry juice, gooseberry juice, blackberry juice, blueberry juice, strawberry juice, pomegranate juice, guava juice, kiwi juice, mango juice, papaya juice, watermelon juice, cantaloupe juice, cherry juice, cranberry juice, pineapple juice, peach juice, apricot juice, plum juice, and the like. Such fruit juices can be natural fruit juices (i.e., obtained directly from the natural fruit), processed fruit juices, reformulated fruit juices, and the like. Although not preferred, the invention is also compatible with beverages containing vegetable juices.

In general, the most preferred beverages are non-carbonated beverages having a pH of about 2.5 to about 4.5, including naturally acidic beverages or acidified beverage. The preservatives are compatible with artificial or natural sweeteners and with other additives typically used in food products, so long as they do not adversely effect the organoleptic properties of the beverage. These additives may include, for example, flavorants, colorants, stabilizers, thickeners, nutrients such as vitamins and minerals, emulsifiers, and antioxidants. When using chitosan, it is preferred that low molecular weight (preferably about 6000 g/mol or less) forms be used because of their relatively small effect on viscosity.

The present invention allows the killing and/or inhibiting growth of microbiological contamination, including that which is introduced with the ingredients and that from environmental sources during handling and packaging. The first and second (if used) antimicrobial compounds are added to a concentration sufficient to reduce and maintain microorganism levels to less than about 1 cfu/ml for at least about 8 weeks at room temperature. It has been found that, for beverages contaminated with microbiological contamination of up to about 104 cfu/ml, the compositions and methods of the present invention are effective for killing the microorganisms present to levels of below about 1 cfu/ml within about 5 weeks and for maintaining the level below about 1 cfu/ml for at least about 8 weeks at room temperature. It is expected that such levels will be maintained below about 1 cfu/ml for longer periods of time unless subsequent contamination occurs (i.e, via failure of primary package). Of course, efforts should be made to avoid and/or reduce microbiological contamination of food products, including beverages, when using the present invention to provide even greater margins of safety.

The first antimicrobial compound is chitosan, tannic acid, or mixtures thereof; chitosan is the preferred antimicrobial compound for use in this invention. The chitosan may be added to a final concentration of about 0.1 to about 200 ppm (preferably about 1 to about 100 ppm). In other embodiments, tannic acid (preferably added to a final concentration of about 10 to about 100 ppm) may be used in the place of, or together with, chitosan. Examples of the second antimicrobial compound include benzoate, sorbate, EDTA, and mixtures thereof. The benzoate or sorbate, when used, is generally added to a final concentration of about 10 to about 1000 ppm (with other appropriate ranges being about 50 to about 500 ppm and about 50 to about 150 ppm); EDTA, when used, should be at a final concentration of about 0.5 to about 300 ppm, with preferred and more preferred concentrations being about 1 to about 100 ppm and about 10 to about 50 ppm, respectively. In a preferred embodiment, the first antimicrobial compound is chitosan and the second antimicrobial compound is a mixture of benzoate, sorbate, and EDTA. Generally, the total level of added antimicrobial compounds should be less than about 2000 ppm, and preferably less than about 1000 ppm, in the relevant food product.

The present invention also encompasses beverages made by the methods discussed above. For example, in a preferred embodiment the present invention includes ready-to-drink beverages containing at least 1 percent fruit juice, about 1 to about 200 ppm chitosan, and about 10 to about 1000 ppm benzoate or sorbate. Other agents, such as tannic acid and EDTA, may also be included. Preferred concentrations are those discussed above and would include, for example, a beverage with about 1 to about 100 ppm chitosan, and about 50 to about 500 ppm of either sorbate or benzoate. Tannic acid can also be added to compositions at a preferred concentration of about 10 to about 100 ppm.

The chitosan used in the methods and compositions described above may be in any molecular form compatible with preparation of a beverage for human consumption. However, in general, the chitosan should have a low average molecular weight (i.e., less than about 50,000 g/mol), with an average molecular weight of less than about 6000 g/mol being preferred. The beverages should generally contain at least 1 percent fruit juice, with concentrations in the range of about 5 to about 95 percent and about 5 to about 50 percent being preferred. They should be acidic, with a pH in the range of about 2.0 to about 6.0 and, preferably, in the range of about 2.5 to about 4.5.

One advantage of the present invention is that it allows for the preparation of beverages using a cold fill packing process. Cold fill processes preferred, the methods and compositions are compatible with hot packing or aseptic packaging operations as well. Methods for making beverage compositions are described, for example, in U.S. Pat. Nos. 4,737,375 and 6,294,214. These methods, or any others known in the art, may all be used with the methods and compositions described herein.

Unless noted otherwise, all percentages or levels used in the present specification are by weight.

### EXAMPLES

### Example 1

A non-carbonated liquid beverage with a pH of less than 4.0 was prepared by blending water, high fructose corn syrup, pear juice concentrate, citric acid, ascorbic acid (vitamin C), and flavor. On a reconstituted basis, the beverage contained 10 percent fruit juice. The beverage was fortified with sufficient ascorbic acid to provide at least 100 percent of the USRDI (U.S. Recommended Daily Intake) of vitamin C. Water of a hardness of about 60 ppm was used to formulate the beverage.

In addition, this beverage was formulated with the following preservatives:
5 ppm of chitosan;
200 ppm of sodium benzoate;
200 ppm potassium sorbate; and
30 ppm EDTA.

The beverage was inoculated with a cocktail of mold species at a level of about 2×10² cfu/ml. The beverage was sealed and placed in a 76° F. chamber. Samples were aseptically extracted and plated to determine the level of mold remaining in the beverage. The table below summarizes the results: are well known in the art and, unlike “hot fill” processes, involve the packing of liquids at a temperature of under about 80° C. and typically at a temperature of between 0 and about 35° C. The use of the present invention in a cold fill process offers a number of advantages, including, for example, improved robustness with regard to high levels of microbial contamination, reduced formulation costs (i.e., relatively low levels of antimicrobial compounds are effective), improved formula flexibility (i.e., preservative system is effective over wide range of water hardness and water alkalinity conditions), improved product flavor (i.e., due to low levels of antimicrobial compounds which can be used and the ability to avoid heat treatment conditions), increased shelf life at ambient temperature, and the like.

The conditions of such cold fill packing may be varied in accordance with the desires of the producer and any constraints imposed by the particular liquid being packaged. Thus, the present invention encompasses an improvement in a cold fill process for the packing of a beverage that is characterized by the addition of chitosan to a final concentration of between about 1 and about 200 ppm. Preferably, sorbate, benzoate and/or EDTA are included in the process at the concentrations described above. When the first and second antimicrobial compounds are used together, no additional preservatives are required. Nevertheless, the method is compatible with other preservatives, coloring agents, stabilizers, and the like, so long as they do not adversely affect the organoleptic properties of the beverage. The method will be most advantageously used for fruit juice-containing beverages as discussed above at a pH of about 2.0 to about 6.0, and preferably at about 2.5 to about 4.5. Tannic acid may also be used in cold fill processes together with chitosan. The tannic acid may be used in any form compatible with food products and should be added to a final concentration of about 1 to about 500 ppm, with preferred final concentrations being about 10 to about 300 ppm and about 10 to about 100 ppm.

The beverages of the present invention can be prepared using conventional methods well known in the art. Although cold filling is generally

| Time (weeks) | Yeast (cfu/ml) |
|---|---|
| Initial Inoculation | 210 |
| 1 | 3 |
| 2 | 2 |
| 3 | <1 |
| 4 | <1 |
| 6 | <1 |
| 8 | <1 |

### Example 2

This example illustrates the effectiveness of using chitosan alone in a cold fill process. A non-carbonated liquid beverage with a pH of less than 4.0 was prepared by blending water, high fructose corn syrup, pear juice concentrate, citric acid, ascorbic acid (vitamin C), and flavor. On a reconstituted basis, the beverage contained 10 percent fruit juice. The beverage was fortified with sufficient ascorbic acid to provide at least 100 percent of the USRDI (U.S. Recommended Daily Intake) of vitamin C. Water of a hardness of about 60 ppm was used to formulate the beverage.

This beverage was formulated with 20 ppm of chitosan; no sodium benzoate, potassium sorbate, or EDTA was added.

The beverage was inoculated with a cocktail of yeast species at a level of about 10³ cfu/ml. The beverage was cold sealed and placed in a 76° F. chamber. Samples were aseptically extracted and plated to determine the level of yeast remaining in the beverage. The table below summarizes the results:

| Time (weeks) | Yeast (cfu/ml) |
|---|---|
| Initial Inoculation | 960 |
| 1 | <1 |
| 2 | <1 |
| 3 | <1 |
| 4 | <1 |
| 6 | <1 |
| 8 | <1 |

### Comparative Example

A similar, but non-inventive, non-carbonated beverage was prepared as in Example 2 except that (1) water with a hardness of about 220 was used and (2) beverage was formulated with a different preservative system. The preservative system provided no chitosan, 250 ppm sodium benzoate, 250 ppm potassium sorbate, and 400 ppm EDTA.

The samples were inoculated with a cocktail of yeast species at a level of about 10³ cfu/ml. Inoculated samples were then treated and evaluated as in Example 2. After 1 week of storage, the growth of yeast was so excessive that counting was not possible; after 2 weeks of storage, the sample had fermented.

### Example 3

A non-carbonated liquid beverage with a pH of less than 4.0 was prepared by blending water, high fructose corn syrup, orange, pineapple, pear and red grape juice concentrate, citric acid, ascorbic acid (vitamin C), and flavor. On a reconstituted basis, the beverage contained 10 percent fruit juice. The beverage was fortified with sufficient ascorbic acid to provide at least 100 percent of the USRDI (U.S. Recommended Daily Intake) of vitamin C. Water of a hardness of about 130 ppm was used to formulate the beverage.

In addition, this beverage was formulated with the following preservatives:
20 ppm of Chitosan;
400 ppm sodium benzoate;
200 ppm potassium sorbate; and
30 ppm EDTA.

The beverage was inoculated with a cocktail of mold species at a level of about 2.5×10² cfu/ml and yeast species at a level of about 1.3×10³ cfu/ml. The beverage was sealed and placed in a 76° F. chamber. Samples were aseptically extracted and plated to determine the level of mold and yeast remaining in the beverage. The table below summarizes the results.

| Time (weeks) | Mold (cfu/ml) | Yeast (cfu/ml) |
|---|---|---|
| Initial Inoculation | 250 | 1260 |
| 1 | 18 | 57 |
| 2 | <1 | 2 |
| 5 | <1 | <1 |
| 8 | <1 | <1 |

### Example 4

A non-carbonated liquid beverage with a pH of less than 4.0 was prepared by blending water, high fructose corn syrup, pear juice concentrate, citric acid, ascorbic acid (vitamin C), and flavor. On a reconstituted basis, the beverage contained 10 percent fruit juice. The beverage was fortified with sufficient ascorbic acid to provide at least 100 percent of the USRDI (U.S. Recommended Daily Intake) of vitamin C. Water of a hardness of about 220 ppm was used to formulate the beverage.

In addition, this beverage was formulated with the following preservatives:
10 ppm of chitosan;
400 ppm of sodium benzoate;
200 ppm potassium sorbate; and
30 ppm EDTA.

Separate samples of the beverage were inoculated with a cocktail of either yeast species or mold species at a level of about 1.7×10² and 44 cfu/ml, respectively. The samples was sealed and placed in a 76° F. chamber. Samples were aseptically extracted and plated to determine the level of mold or yeast remaining in the beverage. The table below summarizes the results.

| Time (weeks) | Mold (cfu/ml) | Yeast (cfu/ml) |
|---|---|---|
| Initial Inoculation | 170 | 44 |
| 1 | <1 | <1 |
| 2 | 1 | <1 |
| 3 | <1 | <1 |
| 4 | <1 | <1 |
| 6 | <1 | <1 |
| 8 | <1 | <1 |

All references cited herein are fully incorporated by reference. Having now fully described the invention, it will be understood by those of skill in the art that the invention may be performed within a wide and equivalent range of conditions, parameters and the like, without affecting the spirit or scope of the invention or any embodiment thereof.

1. A method of killing microorganisms or inhibiting the growth of microorganisms in a packaged food product, comprising adding a first antimicrobial compound selected from the group consisting of chitosan, tannic acid, or mixtures thereof and a second antimicrobial compound, wherein the first antimicrobial compound and second antimicrobial compound are added to a concentration sufficient, in their combined action, to reduce and maintain microorganism levels in the packaged food product to less than about 1 cfu/ml for at least about 8 weeks at room temperature.

2. The method of claim 1, wherein the packaged food product is a packaged beverage.

3. The method of claim 2, wherein the packaged food product is a cold fill packaged beverage.

4. The method of claim 2, wherein the second antimicrobial compound is selected from the group consisting of benzoate, sorbate, EDTA, and mixtures thereof.

5. The method of claim 3, wherein the second antimicrobial compound is selected from the group consisting of benzoate, sorbate, EDTA, and mixtures thereof.

6. The method of claim 2, wherein the first and the second antimicrobial compounds are the only antimicrobial compounds in the packaged beverage.

7. The method of claim 3, wherein the first and the second antimicrobial compounds are the only antimicrobial compounds in the packaged beverage.

8. The method of claim 4, wherein the first and the second antimicrobial compounds are the only antimicrobial compounds in the packaged beverage.

9. The method of claim 5, wherein the first and the second antimicrobial compounds are the only antimicrobial compounds in the packaged beverage.

10. The method of claim 4, wherein the first antimicrobial compound is chitosan at a final concentration of about 1 to about 200 ppm and the second antimicrobial compound, if benzoate or sorbate, is added to a final concentration of about 10 to about 1000 ppm, or, if EDTA, is added to a final concentration of about 0.5 to about 300 ppm.

11. The method of claim 8, wherein the first antimicrobial compound is chitosan at a final concentration of about 1 to about 200 ppm and the second antimicrobial compound, if benzoate or sorbate, is added to a final concentration of about 10 to about 1000 ppm, or, if EDTA, is added to a final concentration of about 0.5 to about 300 ppm.

12. The method of claim 10, wherein the first antimicrobial compound is chitosan at a final concentration of about 1 to about 100 ppm and the second antimicrobial compound, if benzoate or sorbate, is added to a final concentration of about 50 to about 500 ppm, or, if EDTA, is added to a final concentration of about 1 to about 200 ppm.

13. The method of claim 11, wherein the first antimicrobial compound is chitosan at a final concentration of about 1 to about 100 ppm and the second antimicrobial compound, if benzoate or sorbate, is added to a final concentration of about 50 to about 500 ppm, or, if EDTA, is added to a final concentration of about 1 to about 200 ppm.

14. A packaged beverage comprising a first antimicrobial compound selected from the group consisting of chitosan, tannic acid, or mixture thereof and a second antimicrobial compound, wherein the first antimicrobial compound and second antimicrobial compound are added at a concentration sufficient, in their combined action, to reduce and maintain microorganism levels in the packaged beverage to less than about 1 cfu/ml for at least about 8 weeks at room temperature.

15. The packaged beverage of claim 14, wherein the packaged beverage is a cold fill packaged beverage.

16. The packaged beverage of claim 14, wherein the second antimicrobial compound is selected from the group consisting of benzoate, sorbate, EDTA, and mixtures thereof.

17. The packaged beverage of claim 15, wherein the second antimicrobial compound is selected from the group consisting of benzoate, sorbate, EDTA, and mixtures thereof.

18. The packaged beverage of claim 16, wherein the first and the second antimicrobial compounds are the only antimicrobial compounds in the packaged beverage.

18. The packaged beverage of claim 17, wherein the first and the second antimicrobial compounds are the only antimicrobial compounds in the packaged beverage.

19. The packaged beverage of claim 16, wherein the first antimicrobial compound is chitosan at a final concentration of about 1 to about 200 ppm and the second antimicrobial compound, if benzoate or sorbate, is added to a final concentration of about 10 to about 1000 ppm, or, if EDTA, is added to a final concentration of about 0.5 to about 300 ppm.

20. The packaged beverage of claim 17, wherein the first antimicrobial compound is chitosan at a final concentration of about 1 to about 200 ppm and the second antimicrobial compound, if benzoate or sorbate, is added to a final concentration of about 10 to about 1000 ppm, or, if EDTA, is added to a final concentration of about 0.5 to about 300 ppm.

21. The packaged beverage of claim 19, wherein the first antimicrobial compound is chitosan at a final concentration of about 1 to about 100 ppm and the second antimicrobial compound, if benzoate or sorbate, is added to a final concentration of about 50 to about 500 ppm, or, if EDTA, is added to a final concentration of about 1 to about 200 ppm.

22. The packaged beverage of claim 20, wherein the first antimicrobial compound is chitosan at a final concentration of about 1 to about 100 ppm and the second antimicrobial compound, if benzoate or sorbate, is added to a final concentration of about 50 to about 500 ppm, or, if EDTA, is added to a final concentration of about 1 to about 200 ppm.

23. A process for providing a cold fill packaged beverage, the process comprising:
(1) preparing a beverage, wherein the prepared beverage comprises a first antimicrobial compound selected from the group consisting of chitosan, tannic acid, or mixture thereof and a second antimicrobial compound selected from the group consisting of benzoate, sorbate, EDTA, and mixtures thereof;
(2) placing the prepared beverage in an container;
(3) sealing the container to provide the cold fill packaged beverage,
wherein steps (2) and (3) are carried out at a temperature of 0 to about 80° C.; and wherein the first antimicrobial compound and second antimicrobial compound are added to the beverage at a concentration sufficient, in their combined action, to reduce and maintain microorganism levels in the cold fill packaged beverage to less than about 1 cfu/ml for at least about 8 weeks at room temperature.

24. The process of claim 23, wherein the first antimicrobial compound is chitosan at a final concentration of about 1 to about 200 ppm and the second antimicrobial compound, if benzoate or sorbate, is added to a final concentration of about 10 to about 1000 ppm, or, if EDTA, is added to a final concentration of about 0.5 to about 300 ppm.

25. The process of claim 24, wherein the first antimicrobial compound is chitosan at a final concentration of about 1 to about 100 ppm and the second antimicrobial compound, if benzoate or sorbate, is added to a final concentration of about 50 to about 500 ppm, or, if EDTA, is added to a final concentration of about 1 to about 200 ppm.

26. The process of claim 23, wherein the first and the second antimicrobial compounds are the only antimicrobial compounds in the cold fill packaged beverage.

27. The process of claim 24, wherein the first and the second antimicrobial compounds are the only antimicrobial compounds in the cold fill packaged beverage.

28. The process of claim 25, wherein the first and the second antimicrobial compounds are the only antimicrobial compounds in the cold fill packaged beverage.

29. A process for providing a cold fill packaged beverage, the process comprising:
(1) preparing a beverage, wherein the prepared beverage comprises a chitosan;
(2) placing the prepared beverage in an container;
(3) sealing the container to provide the cold fill packaged beverage,
wherein steps (2) and (3) are carried out at a temperature of 0 to about 80° C.; and wherein the chitosan is added to the beverage at a concentration sufficient, to reduce and maintain microorganism levels in the cold fill packaged beverage to less than about 1 cfu/ml for at least about 8 weeks at room temperature.

30. The process of claim 29, wherein chitosan is the only preservative in the cold fill packaged beverage.

31. The process of claim 29, wherein the concentration of chitosan in the cold fill packaged beverage is about 1 to about 100 ppm.

32. The process of claim 30, herein the concentration of chitosan in the cold fill packaged beverage is about 1 to about 100 ppm.

33. The process of claim 31, wherein the concentration of chitosan in the cold fill packaged beverage is about 10 to about 50 ppm.

34. The process of claim 32, wherein the concentration of chitosan in the cold fill packaged beverage is about 10 to about 50 ppm.
